(19) United States
(12) Patent Application Publication
(10) Pub. No.: US 2022/0146622 A1
(43) Pub. Date: May 12, 2022

(54) METHOD AND APPARATUS FOR ELECTROMAGNETIC TRANSMISSION ATTENUATION CONTROL

(71) Applicant: Metawave Corporation, Carlsbad, CA (US)

(72) Inventor: Edmond Kia MEGERDICHIAN, Palo Alto, CA (US)

(21) Appl. No.: 17/429,326

(22) PCT Filed: Feb. 4, 2020
(86) PCT No.: PCT/US20/16650

§ 371 Date: Aug. 6, 2021

Related U.S. Application Data
(60) Provisional application No. 62/801,801, filed on Feb. 6, 2019.

(51) Int. Cl. G01S 7/02; G01S 13/931; H01Q 1/12

(52) U.S. Cl. CPC G01S 7/027; H01Q 1/1271; G01S 13/931

(57) ABSTRACT

Examples disclosed herein relate to an apparatus for attenuation control of a radar signal in a vehicle. The apparatus includes an attenuation control mechanism having at least one property to reduce distortion of a radar signal transmission positioned on a surface of the vehicle, and radiating elements proximate the attenuation control mechanism enabling radiation beams to propagate with reduced distortion.

### CROSS-REFERENCE TO RELATED APPLICATIONS

This application claims priority from U.S. Provisional Application No. 62/801,801, titled “METHOD AND APPARATUS FOR ELECTROMAGNETIC TRANSMISSION ATTENUATION CONTROL,” filed on Feb. 6, 2019, all of which are incorporated by reference herein.

### FIELD OF THE INVENTION

The present invention relates to integrated structures and attenuation control mechanisms, and in particular to sensors in a vehicle.

### BACKGROUND

In automotive applications, a radar system unit may be positioned in a variety of places around a vehicle and is typically positioned externally on the body of the vehicle. The location is dependent on the design and operational specifications for operation in weather and under a range of environment conditions. Radomes are used to maintain the position, calibration and operation of the radar module in these various situations. Often the configuration and materials of a vehicle are not consistent with antenna radiation and radar operation. There is a need to protect radar systems in vehicles to ensure the accurate operation of the radar unit given the various designs and materials used in a vehicle.

### BRIEF DESCRIPTION OF THE DRAWINGS

The present application may be more fully appreciated in connection with the following detailed description taken in conjunction with the accompanying drawings, which are not drawn to scale, in which like reference characters refer to like parts throughout, and in which:

FIG. 1 illustrates a vehicle having a radar system, according to various implementations of the subject technology;

FIGS. 2 and 3 illustrate a vehicle having a radar system and attenuation control mechanisms configured on a windshield of the vehicle, according to various implementations of the subject technology;

FIGS. 4 and 5 illustrate configurations of glass layers and radar transmission components integrated therein, according to various implementations of the subject technology;

FIG. 6 illustrates a vehicle having a plurality of sensors, wherein attenuation control mechanisms are positioned throughout the vehicle according to various implementations of the subject technology;

FIGS. 7-9 illustrate configuration and placement of attenuation control mechanisms enabling radar transmissions on a vehicle, according to various implementations of the subject technology; and

FIG. 10 illustrates a method for designing and integrating an attenuation control mechanism, according to various implementations of the subject technology.

### DETAILED DESCRIPTION

Methods and apparatuses for electromagnetic transmission attenuation control in a vehicle radar are disclosed. In various implementations of the subject technology, an interlayer is positioned between multiple layers of a laminated glass structure. The interlayer may be laminated between panes of glass in a vehicle. In some implementations, the interlayer is made up of multiple layers of material(s) having a desirable combination of strength and transmission characteristics supporting wireless signals, including, but not limited to, radar signals for use in transportation. The interlayer may have optical properties complementing a laminated glass structure or may be opaque.

Laminated glass is generally made by laminating two layers of glass with a film interlayer of vinyl or other material acting as an adhesive to maintain the integrity of the glass sheet on impact. The interlayer disclosed herein provides shatter resistance in a strong, optical shield that also provides solar heat shielding and an acoustic barrier for the safety and comfort of the driver and passenger in the vehicle. The windshield is in a good location on a vehicle for a radar system, however, the laminated glass is not ideal for wireless transmissions as it introduces a discontinuity in the medium through which the electromagnetic waves propagate. In a radar system, laminated glass is often an unacceptable medium for wave propagation as it will attenuate the wave and distort the radar signal. The behavior of a given medium is affected by the frequency of the transmission.

The present disclosure provides a structure integrated with the laminated glass of a windshield, wherein the structure provides a good transmission medium for radar and enables the radar to be placed within the vehicle, protecting the radar system. The radar system detects objects, the relative location of those objects and other characteristics, and is used in ADAS and autonomous vehicle operation. The radar system has a transmitter generating electromagnetic waves through an antenna and a receiver to receive reflections of the transmitted waves as they return from an object, referred to as a target. The received signals are then processed to determine properties of the object, including size, location, velocity and so forth. All of these require carefully and accurately calibrated operation. Protection is therefore important for a radar system as reliability is directly related to the accuracy of operation.

By integrating with the layers of the laminated glass, a protection structure uses the protection of the vehicle to isolate the radar system from the environment and operation of the vehicle. In some implementations, the integration is achieved by a shape of the protection structure wherein different length portions couple with complementary sized portions of the laminated glass. This provides flexural strength and stability for the entire windshield and the protection structure, specifically.

As the radar system is conventionally positioned external to the vehicle, a radome structure is configured to protect the radar system. The radome encloses the radar system, or portions thereof, such as the antenna, from the environment. This provides cover and protection in a range of environments and weather conditions. In addition to protecting the radar system, the configuration and material of the radome allow transmission of electromagnetic radiations from an antenna in a variety conditions, such as when subjected to rain, snow, ice, dirt and other conditions that may impact the accuracy of the radar operation.

The radome acts as another layer of the radar system positioned over the antenna to protect the antenna from damage and harmful effects. There are a variety of designs for radar systems, and each will require a different scope of protections. The radome design is defined by its geometry and material composition, as well as the acceptable insertion and other losses of the signal passing through the radome. These losses will degrade the antenna pattern of a radar system and are critical to proper, consistent operation.

In addition to the strict operational specification of the radar system, the design also considers placement of the radome, material and shape of the radome, the space required for the radome structure, and the cost of the radome and placement. These considerations compete with each other and may result in less desirable positioning and lower performance of a powerful radar unit.

The present disclosure provides a method for protecting the radar system using the vehicle composition as a radome and enables positioning the radar system or module for protection from the vehicle body. Placing the radar system within the vehicle uses the robust components that are designed to optimize human safety. The same components that provide security to passengers act as barriers to full and proper operation of a radar unit. The windshield for example will distort and attenuate a transmission signal, not only reducing the range of the radar but scattering the signal and interfering with the antenna pattern.

The present disclosure describes methods and apparatus for protecting radar operation from antenna pattern distortion and loss by providing a radar protection unit or attenuation control mechanisms for radar systems. The material of the radar protection unit allows wave propagation for the radar system and enables the radar system, and the antenna in particular, to be placed within the vehicle. In some of the implementations illustrated herein the antenna is positioned behind a windshield, protected by a protective layer integrated with the laminated glass layers of the windshield providing structure to the protective layer. The radar system unit is placed behind the windshield in a place that does not interfere with visibility through the glass for the driver. The attenuation control mechanisms are made of a material or materials having electromagnetic properties that enable antenna transmissions to pass with little distortion and may be made of a variety of materials. The present disclosure describes composite structures that enable wireless transmissions to pass through with less antenna pattern degradation due to the electromagnetic properties of the composite structure. In some implementations, the components are material compositions integrated with glass, and in some implementations, the compositions are designed to consider and correct for distortions due to glass, plastic or other materials.

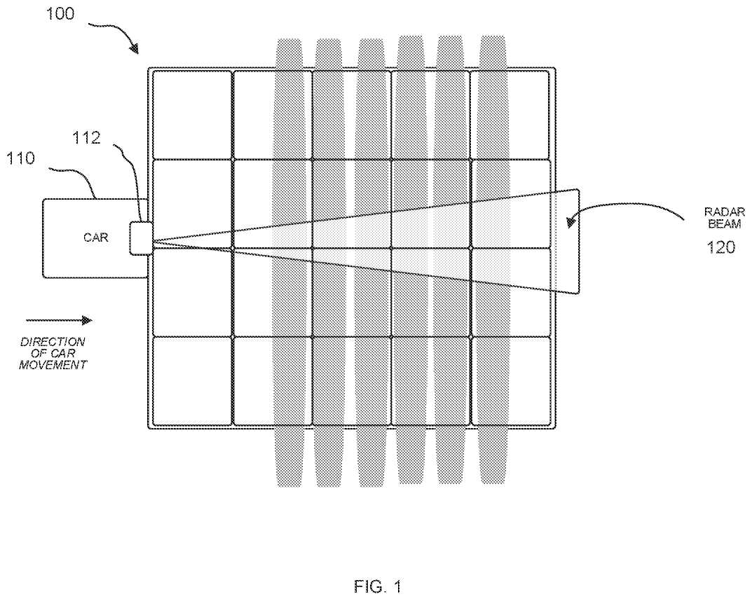

FIG. 1 illustrates a vehicle having a radar system, according to various implementations of the subject technology. Vehicle 110 includes a radar system 112 as a sensor for object detection. In this illustrated implementation, the radar system 112 is positioned within the vehicle housing, such as behind the windshield on the interior of the vehicle. The position of radar system 112 may be the location of the radar antenna, where other components of the radar system 112 may be distributed throughout the vehicle. The antenna is positioned to generate a radar beam 120, which is illustrated directed to boresight. The entire radar system 112 includes multiple components, including the antenna, transceiver, feed network and so forth, which may be placed as indicated in FIG. 1. The radar system 112 may be positioned at other locations as a function of design goals. Modular designs may position different components of radar system 112 at different locations within vehicle 110 and may combine functions with other operational units in the vehicle 110, such as to cohouse with other sensors, including other radar sensors. For purposes of the present discussion, the radar beam 120 is directed in the path of the vehicle which is moving within environment 100.

The radar beam 120 may be a static beam or may be steered in azimuth and/or elevation to scan the environment 100. In some implementations, a radar unit is positioned on the side or rear of a vehicle for object detection around the vehicle. The position of radar system 112 influences the accuracy and efficiency of operation. For example, in a large truck there may be a radar positioned to detect low hanging structures such as bridges, tunnels, parking structures, toll booths and so forth. In a vehicle 110 the radar system 112 transmits signals from the vehicle and receives the echoes of these signals using a transceiver (not shown). Such transmissions and returns are facilitated by one or more antennas having radiating elements. The antenna cannot transmit signals through materials having physical or electromagnetic properties that interfere with transmission of that energy, such as through laminated glass common in vehicles.

In some implementations, antennas are embedded into portions of the vehicle, such as within the windshield; however, such designs may introduce an unacceptable level of distortion to the antenna pattern when used for object detection from a moving vehicle due to the safety glass. The glass composition of the windshield, or other window, is designed for visibility and safety without consideration of the ability to transmit radar signals through the glass.

Also, as vehicle design complexity increases, the design spacing and footprint available for devices are constrained. The available real estate for the many systems required in a self-driving car and/or the many functions included in a vehicle is very limited. Couple this with the vehicle designers goals to reduce or optimize the weight of the vehicle to reduce cost and increase the efficiency of the vehicle and it is clear there is a desire to reuse space and structures in the vehicle for multiple functions.

The present disclosure provides methods and apparatuses for positioning a radar unit or system within a vehicle and thus providing expanded and improved protection. In some implementations described herein the vehicle windshield provides this protection with the radar unit positioned within the vehicle, although there are other locations that may be used for positioning a radar unit. In each scenario, the location is selected to protect the radar system from external, environmental and other effects that may cause attenuation, distortion, losses and so forth. By positioning the radar system within the vehicle, such as behind the windshield, the vehicle's structure protects the radar components and thus ensures the consistency and accuracy of operation.

The windshield in particular is a good position for a radar unit, as it is in the direction of forward movement of a vehicle and has portions where visibility is not generally considered critical, such as at the upper corners or upper portion. A radar unit for object detection in a vehicle positioned at a high elevation on the vehicle is able to direct a beam with a large field of view from the top of the vehicle to the road surface in the elevation or vertical direction. While this position may be desirable, the material and make up of a windshield is not suited for radar use. Windshields are made of safety glass, a laminated product having multiple layers, wherein the windshield introduces interference to radar transmissions with losses and distortion effects. This composite of multiple material layers, laminated together, and designed to hold together when shattered and thus reduce injury on impact has interlayers to bond the glass layers improving its strength and shatterproof characteristics. The interlayer material may be any of a variety of bonding materials. This layered structure further alters any radiation signals passing through the windshield. In this way, the windshield and other materials on the vehicle structures act to attenuate, distort or otherwise interfere with the transmission beam from the radar.

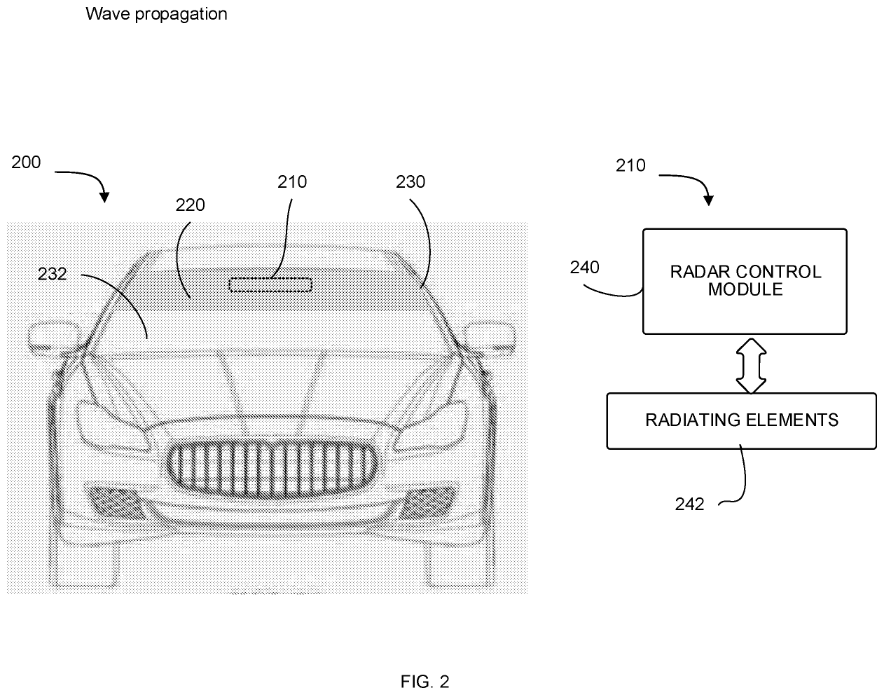

The present description discloses the use of a radar protection structure that is a distortion free material, such as a non-glass material, to protect the radar from unwanted effects, such as distortions and attenuations. In some implementations, the radar protection structure forms a multi-layer structure that integrates with the windshield glass and is placed in a portion of the windshield that will not impact visibility but will avoid and/or reduce radar losses, attenuation and interference of the glass laminate composite. In the illustrated implementation of FIG. 2, the radar protection structure is positioned at the upper edge of the windshield, positioned to be in the non-critical visibility portion of the windshield. In alternate implementations, the radar protection structure may be positioned on a window of a vehicle or other places within a vehicle and with the radar system protected by the radar protection structure. With the radar protection structure, the radar system is able to radiate beams through the radar protection structure without distortion. The radar system operation may be configured to anticipate any effects of the radar protection structure thus enabling consistent reliable operation. Unlike laminated glass structures which introduce unacceptable and uncontrolled distortions, the radar protection structure is designed to pass radiation with little to no distortion. In the present implementation, the radar protection structure is positioned proximate the laminated glass, having multiple layers of different dimensions that are interlaced with the glass and interlayer(s). The radar protection structure acts as an attenuation control mechanism to protect the antenna and aperture of the radar system.

FIG. 2 illustrates a vehicle 200 having a radar system and radar protection structure configured on a windshield of a vehicle. The vehicle 200 has a windshield 230 with a radar system positioned within the vehicle and located at the upper edge of the windshield 230 at a position identified by the dashed lines outlining placement of the radar system. The windshield 230 includes a glass portion 232 and a radar protection portion 220. The location of the radar system is identified by the dashed lines outlining the footprint of the radar system (not shown).

The vehicle 200 may operate the radar system 210 for a variety of purposes by radiating beamforms in antenna patterns; wherein the radar system 210 includes a radar control module 240 coupled to antenna radiating elements 242. The antenna radiating elements 242 may be positioned proximate the windshield 230 or embedded therein having radar protection structure 220 positioned to avoid distortions of transmitted and received signals. As illustrated, the radar protection structure 220 is positioned across the top of the windshield 230; alternate implementations may implement a radar protection structure in a different location and geometry to accommodate a variety of designs.

The radar system 210 may be a modular system, having a radar control module 240 located separate from the radiating elements 242 while still enabling control and operation. The radar system 210 may include a transceiver, antenna control, feed mechanisms, power division control, amplification, and other functional units and circuits as required per the design within or proximate either module 240 or 242 or may position them separate therefrom. The modular approach allows for the radar components to be positioned where optimal. This enables cost savings and space optimization enabling the vehicle designer flexibility in design. The radiating elements 242 in the present implementation are positioned behind and/or proximate attenuation control mechanism 220, which is also referred to herein as a radar protection structure. Examples of attenuation control mechanisms are described in examples and implementations illustrated herein.

In some implementations, the attenuation control mechanisms may be a composite of materials, a substrate with bumps, and so forth. The attenuation control mechanisms are designed to reduce distortions and so design of these is coordinated with design of the antenna or radiating elements, its aperture size, frequency of operation and other operational criteria.

The attenuation control mechanism may also be built into the radome covering of the radar module using a material that compensates for any distortions due to the configuration, placement, makeup and application of the radar module. In some implementations, this may be a coating on the radome or on the glass in which a radar module is embedded. Where the radar is exposed to the elements, rain, snow and so forth, a hydrophobic coating may be used to surface coat the radome or radar module to mitigate any environmental impacts.

In the implementations presented herein the attenuation control mechanisms are non-glass material structures positioned proximate a glass or other portion of the body of a vehicle and integrated therewith. The example attenuation control mechanism 220 is integrated with the laminated glass of the windshield 230 to provide stability and maintain position. The material composition of attenuation control mechanism 220 may be a material such as an acrylonitrile butadiene styrene (ABS), which is a common thermoplastic polymer, a polycarbonate, or other material having little to no energy loss for radar applications allowing radar waves to pass through the attenuation control mechanism 220 without attenuation.

As illustrated with vehicle 200, the attenuation control mechanisms 220 are a composite portion embedded in the glass of the windshield 230. A radar control module 240 may be positioned within the vehicle and may have distributed components that are coupled to the radiating elements 242 which are positioned proximate the attenuation control mechanisms 220 such that the transmissions are approximately undistorted or the distortion of the glass is compensated by the attenuation control mechanisms 220.

The radiating elements 242 may take any of a variety of forms, such as super elements on a transmission line, tiled element array, phase array antenna, meta-structure antenna, metamaterial antenna, slotted or any other type of antenna. In the present implementation, the radiating elements are super elements having a plurality of radiating elements positioned thereon.

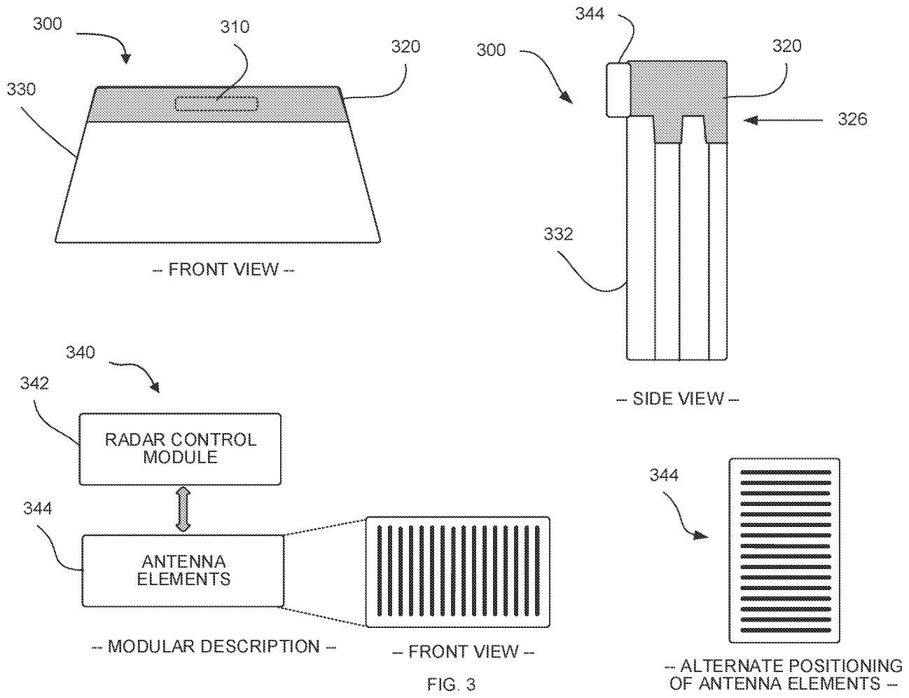

FIG. 3 illustrates a vehicle portion 300 with a windshield 330 having attenuation control mechanism 320, which is a composite structure formed with the glass layers 332 of the windshield 330 and forming a reduced (or no) distortion portion of the windshield 330 enabling antenna elements 344 to radiate as designed. The attenuation control mechanism 320 may be designed to create a simulation of an environmental condition, or they may be designed in collaboration with the radar system 310 so that the radar will perform accurately and as designed. There are a variety of designs and configurations contemplated where the attenuation control mechanism is positioned in a different location, the radar system is a distributed system, different materials are used for the attenuation control mechanism and so forth, wherein each of these designs and configurations results in reduced or controlled attenuation of radar transmissions while protecting the radar system components. The shape of the attenuation control mechanism is sized to correspond to the aperture and angular range of radar transmissions such that transmissions pass through the attenuation control mechanism 320.

The illustration of a side view of the windshield 330 details the integration of the glass layers 332 with the attenuation control mechanism 320 having interleaved portions 326. There may be any number of layers to the attenuation control mechanism 320 which may have varying lengths for integration with the glass layers 332.

Generally, there is a first structural layer that is used for a first function, such as the glass layers for a windshield or window, and a second structural layer that is used for the attenuation control, such as attenuation control mechanism 320. The integration of the first and second structural layers may take any of a variety of forms and geometries, enabling the radar protection.

Continuing with FIG. 3, the radar system 340, including at least the antenna elements 344, is positioned within the vehicle and proximate the attenuation control mechanism 320. The position is illustrated as location 310, dashed lines. In a modular design a radar control module and other modules may be positioned throughout the vehicle while antenna elements may be positioned near the attenuation control mechanism. There may be multiple radar systems within a vehicle, such as to have multiple antennas positioned for detection schemes, wherein a central controller (not shown) communicates and coordinates the various radar systems. The definition of radar system is not meant to be limiting but may include any module, software or hardware involved with the radar operation.

The material of attenuation control mechanisms 320 may be similar to that of a radome, or structural, weatherproof enclosure that serves to protect the radar antenna or radiating elements while introducing minimal attenuation of the electromagnetic signals transmitted and received by the antenna. The attenuation control mechanisms 320 may be a layer of material or multiple layers of material(s). The specific structure will be a function of the operation, range, structure and characteristics of the radar system and the vehicle. For example, object detection at 200 m in front of the vehicle for movement at 100 km/hour will have require very strict accuracy of the radar system, while detection at 10 m behind a vehicle for reverse movement may have a less strict requirement allowing different materials and constructions for the attenuation control mechanisms.

The vehicle portion 300 includes a radar control module 342, which may be positioned proximate the windshield 330. The module 340 includes a radar control module 342 coupled to antenna elements 344. The antenna elements 344 are positioned so as to radiate through the attenuation control mechanisms, and may be parallel to planar attenuation control mechanisms, as shown in FIG. 3. The attenuation control mechanisms 320 are integrated with the glass layers 332 in this application and are configured to be coupled to the glass layers 332. As the windshield may be configured of multiple layers and films, the attenuation control mechanisms may be built into one or more layers or may be constructed separately and then combined with the glass structures. In this application, the antenna elements 344 are positioned on one side of the attenuation control mechanisms 320.

As discussed hereinabove, the attenuation control mechanisms may take any of a variety of shapes and may extend beyond the surface(s) of the windshield, such as spherical, cubical, and so forth. The application, radar design and vehicle design determine the material(s) used, such as fiberglass, polytetrafluoroethylene (PTFE), transparent materials, opaque materials, and so forth. The transmission parameters of the material of the attenuation control mechanism medium determine the applicability for a given frequency range and integration with laminated glass or substrate. This includes the transmission coefficient, the reflectivity coefficient and others which determine the attenuation, scattering, distortion and so forth of transmission waves.

In some implementations, the structure of the attenuation control mechanisms or protection structure, such as structure 320, is a solid piece having no internal discontinuities, boundaries, or layers. In other implementations, the structure may have multiple layers coupled together. The illustrated examples herein consider a tongue and groove connection method, however, alternate methods may be implemented, such as dove tail coupling, lap joint or dodo joint as examples. Some integration may be done when building the glass windshield, or the protection structure may be part of the glass lamination process, or built in later.

In some implementations, the attenuation control mechanisms may reuse a structure of the vehicle, such as a nose cone in an airplane or a rear-view structure in a car. The material(s) selected may be purposed to also reduce environmental conditions, such as to reduce icing in cold environments. In some implementations, the attenuation control mechanisms are designed to provide feedback to the radar system, wherein the feedback about distortions and attenuations caused by changing environmental conditions or operating conditions is used to steer the beam of the radar to compensate for such conditions.

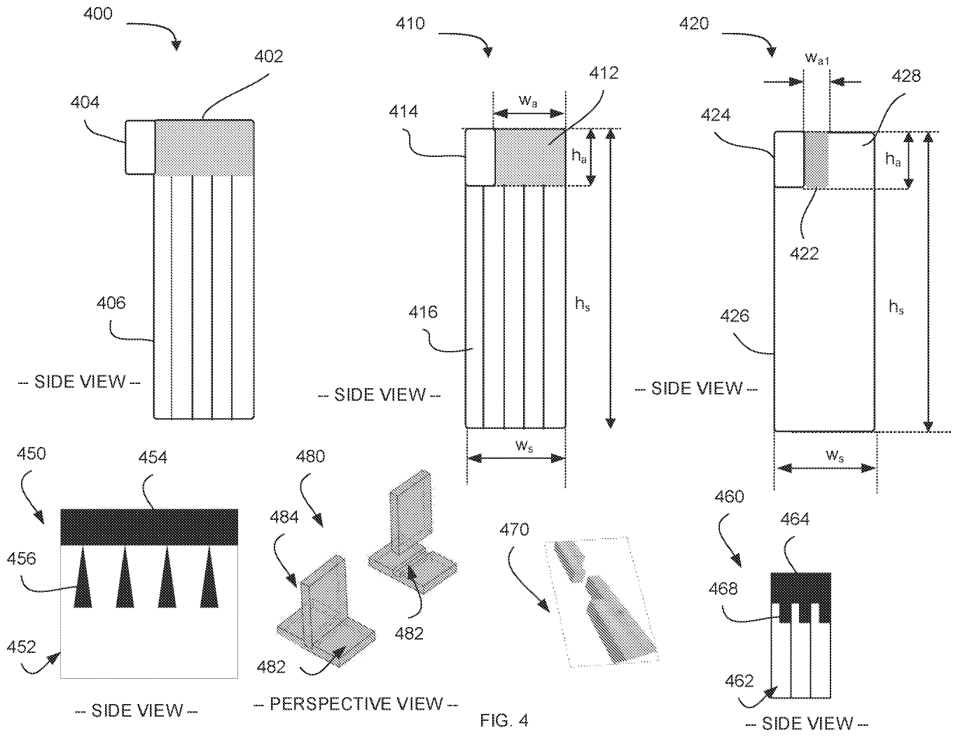

FIG. 4 illustrates configurations of glass layers and radar transmission components integrated therein, according to various implementations of the subject technology. Side views of the various configurations include positioning a radar system at different locations. Structure 400 has attenuation control mechanism 402 coupled to the glass layers 406 and which may include different shapes for various integrations. The radiating elements 404 are positioned on a surface of the attenuation control mechanism 402 on an inside surface of the structure 400. In another implementation, structure 410 has a configuration placing both the attenuation control mechanism 412 and the radiating elements 414 within the extended footprint of the structure 410. In this implementation, the width of the structure is given as wₛ and the width of the attenuation control mechanism 412 is wₐ. As the width of attenuation control mechanism 412 is less than that of structure 410, the radiating elements 414 are embedded proximate the attenuation control mechanism 412 and within the extended windshield footprint defined by width (wₛ) by height (hₛ). In another example, the attenuation control mechanism 422 and the radiating elements 424 are embedded within the extended structure 420 footprint (wₛ×hₛ). The width of attenuation control mechanism 422 wₐ₁ and the material are designed to operate with a portion 428 of the material of the structure 426.

There are several methods for coupling an antenna control mechanism to a substrate, such as the dovetail configuration of structure 450, the lap joints in structures 460 and 470, and the doda coupling of structure 480 shown in two positions. Structure 450 illustrated from a side view comprises a substrate 452, an attenuation control mechanism 454 which is integrated and fixed into a combination with the substrate 452 by way of dovetail portions 456. In structure 480, attenuation control mechanism 484 is coupled to substrate 482 by way of a doda joint 482. A lap joint is illustrated in structure 470 and implemented in structure 460, having substrate layers 462, attenuation control mechanism 464, and connecting portions 468. There are a variety of coupling methods and configurations for providing the radar protection structure on a substrate such as laminated glass.

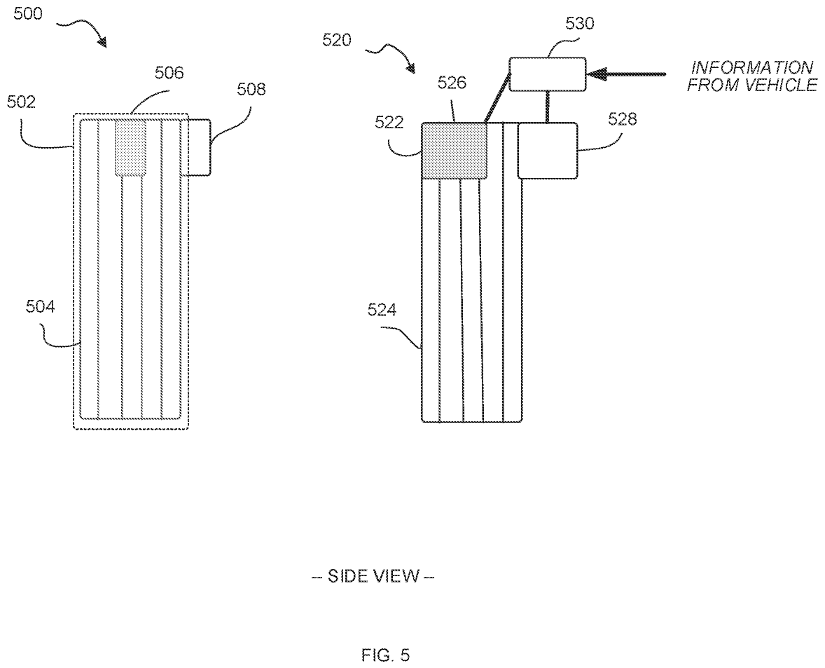

The structure 500 of FIG. 5 has the attenuation control mechanism 506 positioned within and sandwiched between the glass layers 504, similar to attenuation control mechanism 422 of FIG. 4. The radiating elements may be configured proximate attenuation control mechanism 506 within the footprint 502 of structure 500 or may be within radar control module 508. The footprint 502 of the structure 500 determines the available space for attenuation control mechanisms 506 and antenna structures. Structure 520 is similar to structure 500 with the addition of feedback control 530 coupled to the attenuation control mechanism 526 and the radar system 528, wherein radiating elements are within radar system 528. Some implementations detect conditions of the structure 520 and/or the attenuating control mechanism 526 and provide this information or measure to feedback control unit 530. This may be a humidity detection, a temperature detection or other information received from within a vehicle. This information and/or an indication related to this information is provided to the radar system 528. For example, a weather system within the vehicle may indicate that the temperature is increasing or decreasing and thus there may be water or ice on the windshield. The radar system 528 may control the radar beams and interpret received signals to accommodate for the attenuation and impact of such feedback, and so forth.

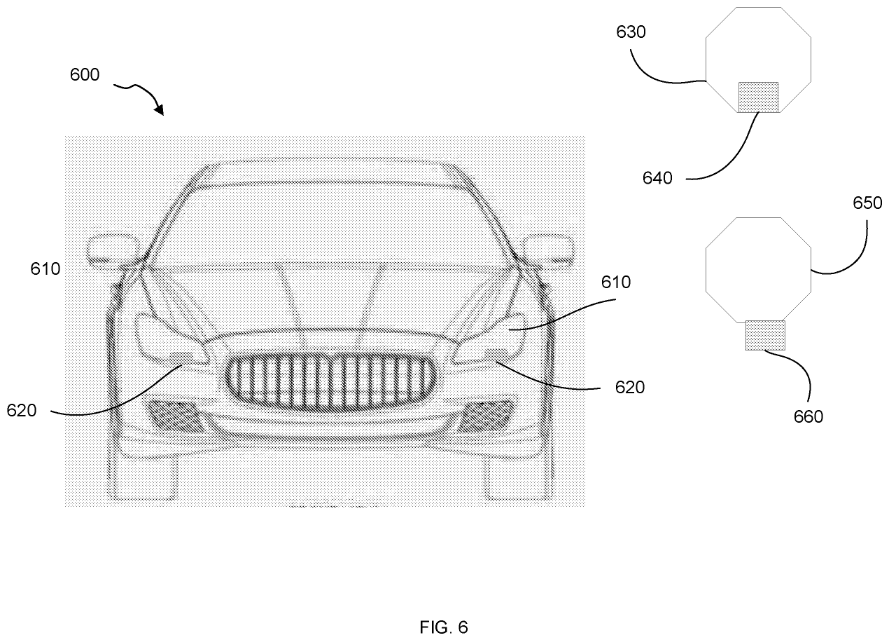

FIG. 6 illustrates a vehicle having a plurality of sensors, wherein attenuation control mechanisms are positioned throughout the vehicle, according to various implementations of the subject technology. The vehicle 600 has attenuating control mechanisms 620 positioned within the headlight structures 610. The radiating elements are positioned proximate the attenuating control mechanisms 620 such that their radiating signals are not attenuated or that such attenuation is controlled or compensated for in operation of the radar system (not shown). Similar to the windshield configurations, placing radar antennas within the vehicle headlights provides protection to the radar unit. In some implementations, the attenuation control mechanism may be effectively built into the headlight cover.

There are a variety of locations on vehicle 600 where attenuating control mechanisms and radar systems may be positioned to take advantage of the shape and construction of the vehicle and thus reduce the footprint of the radar system, including the attenuating control mechanisms and structures. Some of these areas are implemented with plastics and polymers that may have materials that may be adjusted to achieve the properties sufficient for attenuation control. In some headlight housings, ABS is cat onto the back of the housing and may be extended to the front portion of the housing to provide radar protection. Headlight 630 has a shape within which an attenuation control mechanism 640 is included within the shape and footprint. Such a design may be built as a single unit. In another implementation, a headlight 650 has an attenuation control mechanism 660 positioned outside the headlight 650 footprint and may be built as a single unit with the headlight. The selection of material for the attenuation control mechanism in each situation will consider the material of the vehicle structure used, its properties and its geometry.

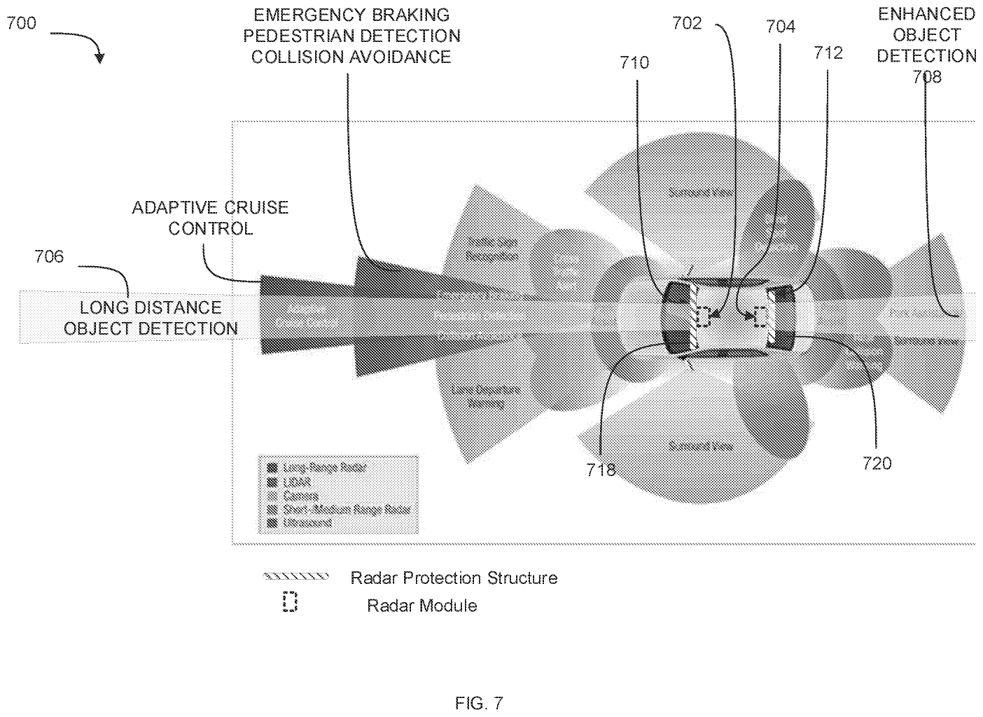

FIG. 7-9 illustrate configuration and placement of attenuation control mechanisms enabling radar transmissions on a vehicle, according to various implementations of the subject technology. FIG. 7 illustrates a vehicle system 700 which illustrates several of the areas covered by potential sensors and corresponding configurations. The sensors include radar units for adaptive cruise control, and object detection for short and long range. Further included are LIDAR, camera and ultrasound sensors. These sensors enable a view of the vehicle's environment and path, as well as activity of other drivers and the driving precision of the driver (lane departure warning and so forth). The sensors are designed into the vehicle shape and configuration.

Each of the sensors of the vehicle system 700 has one or more sensor fields of view for different purposes. The radar module 702 is positioned inside and at the front of the vehicle and is protected by protection structure 710 positioned with the radar and having a long distance object detection field of view 706. The field of view 706 may be a scanning beamform that moves in the azimuth, elevation or both. Positioning the radar module 702 at the top of the vehicle extends the range of the field of view 706. Similarly, a radar module 704 is positioned inside and at the back of the vehicle for enhanced object detection. The radar module 704 has a corresponding radar protection structure 712 integrated into the back windshield.

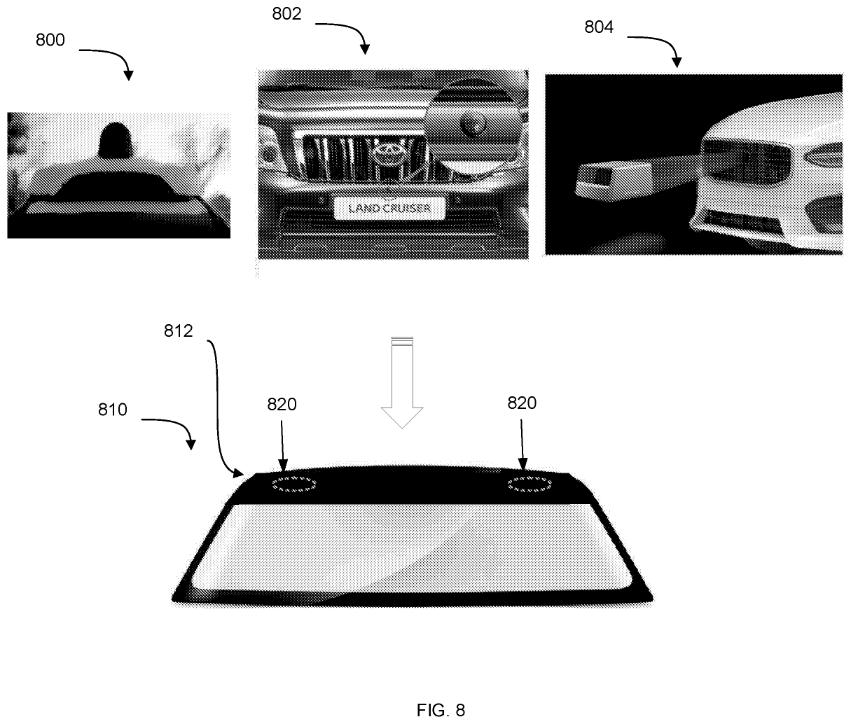

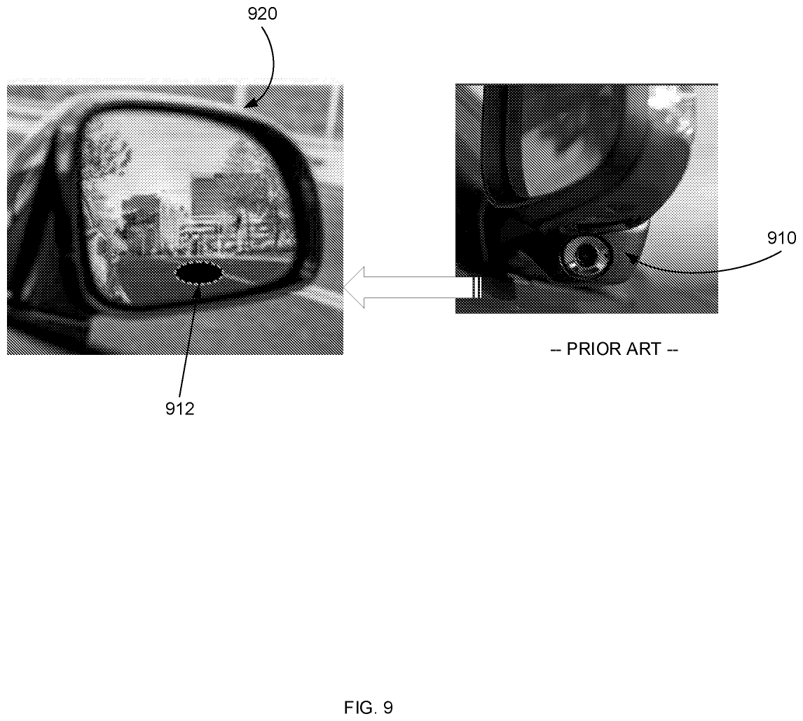

Examples of placement of sensors are illustrated in FIGS. 8 and 9. In the illustration of a front bumper 800, a radar system and attenuating control mechanism may be positioned within the camera space using some of the covering materials that protect the camera. Such a radar positioning would not be impacted by rain or snow but could include a feedback system to adjust the beam direction, focus and or scan to accommodate any environmental conditions that may impact the attenuating control mechanism.

In FIG. 8, a LIDAR unit is positioned on the top of a vehicle 800, on the grill of vehicles 802, 804. For these positions, a strong housing and protection are required to protect the device from the elements. As illustrated in vehicle 810, an attenuating control mechanism 820 may be used in the windshield 812, or other location, enabling placement of the lidar unit 820 within the vehicle and protected by the attenuating control mechanism 812. In this example, the attenuating control mechanism 812 is integrated with the glass layers of the windshield. A lidar unit has lens and barrel covers made of a resin having specific optical, transparency and temperature characteristics. These resins are resistant to high heat, withstand weather conditions, have IR transparency and can tolerate impacts. And most critically, they must support the transmissions through the covers. These materials and configurations may be built into a windshield or other part of a vehicle body to provide protection.

FIG. 9 illustrates an external camera 910 positioned in the location of a typical side-view mirror. In this implementation, the protection mechanism 912 may be configured on the mirror portion of the rearview mirror and the camera positioned within the mirror housing 920. For a camera implementation the protection mechanism 912 is designed according to the camera requirements and requires light to pass through the mechanism 912. The camera may be built into a window, windshield, mirror or other portion of the vehicle body and a protection mechanism as described herein may be used to protect the camera which sits within the vehicle. There are a variety of other applications that may be implemented using the attenuation control mechanism solutions.

The camera housed in the rearview mirror may also display to the mirror portion so that the mirror is replaced with a camera display. In some implementations, this information is presented to a driver within the vehicle as well. Using a camera to replace the mirror reduces the footprint of this part of the vehicle as well as improves visibility as the display may be positioned near the driver for Automated Driver Assist System (ADAS) feedback.

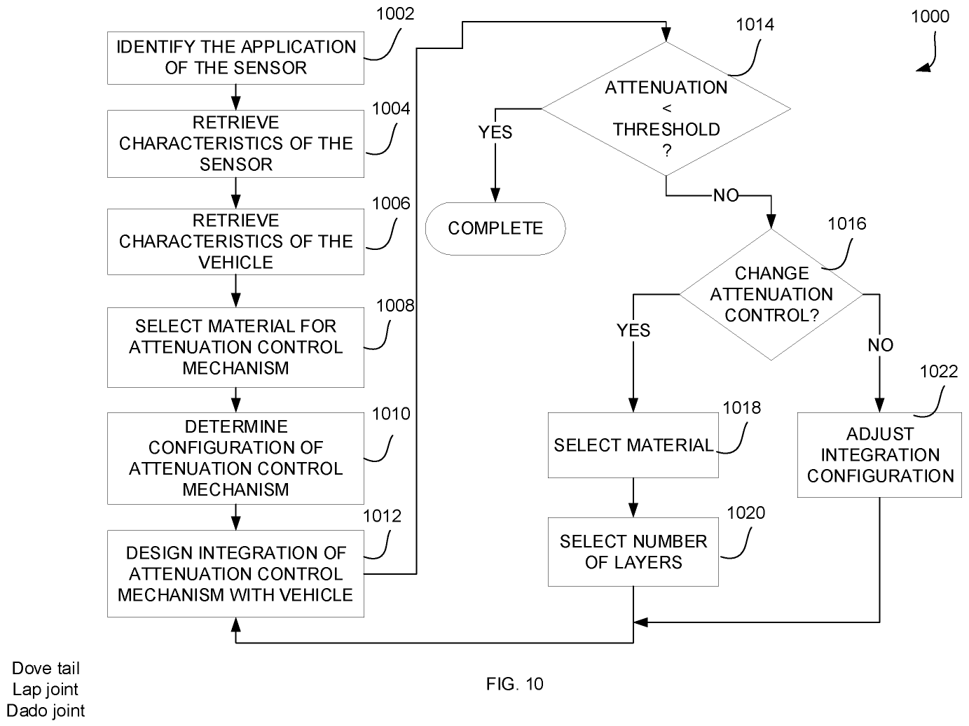

FIG. 10 illustrates a method for design and integration of an attenuation control mechanism in a vehicle to protect a sensor, such as a radar system. The process 1000 identifies the application for the sensor, 1002, including determining the type of sensor, the type of information to be collected and detected, the type of vehicle, placement of the sensor, electromagnetic properties required for protection and operational characteristics of the sensor. The process then retrieves characteristics of the sensor, 1004, both physical and operational. Physical characteristics may include, but are not limited to, geometry, dimensions, and if the sensor is part of a distributed system. Operational characteristics of the sensor may include, but are not limited to, the range of operational frequencies, the type of transmission modulation, the field of view of the radar, and others. The process includes retrieving the vehicle characteristics, 1006, to assist in placement and integration of the attenuation control mechanism with the body of the vehicle, such as into a windshield. The vehicle characteristics include both physical and operational criteria, such as the materials used for the windshield or other substrate supporting the attenuation control mechanism, the configuration of materials, such as laminated layers of glass in a windshield, the geometry and curvature of the substrate, driver visibility, safety construct and so forth. Selection of the material, 1008, enables determination of a configuration for the attenuation control mechanism in the vehicle, 1010. The design describes the integration with the vehicle, 1012. If the attenuation with the attenuation control mechanism meets specification for the sensor and application, 1014, the design is complete. Else, the process determines if there is to be a change in the attenuation control mechanism, 1016, or an adjustment to the integration configuration, 1022. To change the attenuation control to meet the attenuation spec, a material is selected, 1018, the number of layers determined, 1020, and the design proceeds, 1012. This process may be used to determine the acceptable performance of a sensor. Where a coarse measure is sufficient, as this will impact the protection structure build and may result in the use inexpensive materials may be used for the attenuation control.

The present disclosure provides methods and apparatus to provide attenuation control for radiating elements enabling these control mechanisms to be positioned in a variety of locations of the vehicle. In some implementations, the attenuation control mechanisms are materials embedded in, or coupled to, the windshield of the vehicle. In other implementations, the attenuation control mechanisms are integrated into areas of a vehicle that allow for reuse of the footprint, such as at camera or LIDAR sensor locations. In some implementations, the attenuating control mechanisms provide feedback to a radar control module to compensate for environmental, operating or other conditions that may impact the radiation patterns. The radar control may then adjust the beam direction, scanning, steering and so forth.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. The present disclosure is not intended to be limited to the examples shown herein but is to be accorded the widest scope consistent with the principles and novel features disclosed herein.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Moreover, the separation of various system components in the aspects described above should not be understood as requiring such separation in all aspects, and it should be understood that the described program components and systems can generally be integrated together in a single hardware product or packaged into multiple hardware products. Other variations are within the scope of the following claim.

What is claimed is:

1. A control mechanism in a vehicle, comprising:
an antenna positioned within a vehicle; and
an attenuation control mechanism having at least one property to reduce distortion of a radar signal transmission, the attenuation control mechanism positioned between the antenna and a portion of the vehicle, wherein the attenuation control mechanism is integrated into the portion of the vehicle.

2. The control mechanism as in claim 1, wherein distortion is attenuation of the radiation beams.

3. The control mechanism as in claim 2, wherein the attenuation control is interleaved with layers of the portion of the vehicle.

4. The control mechanism as in claim 2, wherein the antenna is part of a radar module.

5. The control mechanism as in claim 4, wherein the portion of the vehicle is a windshield having laminated layers.

6. The control mechanism as in claim 5, wherein the attenuation control mechanism comprises a layer of a material having the at least one property.

7. The control mechanism as in claim 6, wherein the material is ABS.

8. The control mechanism as in claim 2, further comprising:
a radar control module coupled to the antenna; and
a feedback control module coupled to the attenuation control mechanism and the radar control module,
wherein the feedback control module provides information to the radar control module in response to changes in an environment of the vehicle.

9. The control mechanism as in claim 8, wherein the feedback control module provides information to the radar control module in response to changes in operation of the vehicle.

10. The control mechanism as in claim 1, further comprising:
at least one layer of glass material; and
at least one layer of an attenuation control material coupled to the at least one layer of glass material.

11. The control mechanism as in claim 10, wherein layers of the attenuation control material are interleaved with layers of the glass material.

12. The control mechanism as in claim 11, wherein the attenuation control material is a transparent material.

13. The control mechanism as in claim 1, wherein the attenuation control mechanism is positioned at the top portion of a windshield.

14. A method for integrating a radar system into a vehicle, comprising:
selecting a material and configuration for a radar protection structure as a function of a type of vehicle, characteristics of the radar system, and an acceptable attenuation of radar signals;
positioning the radar system in the vehicle;
determining the geometry of the radar protection structure; and
integrating the radar protection structure with the vehicle.

15. The method of claim 14, wherein selecting the attenuation control material comprises evaluating changes in wavelength as a signal propagates through the attenuation control material.

16. A system, comprising:
a radar module comprising an antenna structure and a control unit;
a radar protection structure comprising multiple layers of a transmissive material; and
a portion of a vehicle comprising multiple layers of an attenuating material,
wherein the multiple layers of the transmissive material are integrated with the at least a portion of the multiple layers of the attenuating material to form a vehicle structure, and the radar module is proximate the radar protection structure within the vehicle.

17. The system as in claim 16, wherein the multiple layers of the transmissive material are different lengths complementing the multiple layers of the attenuating material to form a vehicle structure.

18. The system as in claim 17, wherein the vehicle structure is a windshield having the radar protection structure positioned at a top of the windshield.

19. The system as in claim 18, wherein the windshield comprises laminated layers of glass.

20. The system as in claim 18, wherein the laminated layers of glass attenuates an antenna radiation pattern beyond an acceptable threshold, and wherein the radar protection structure has an acceptable attenuation level.
